(19) United States
(12) Patent Application Publication
(10) Pub. No.: US 2025/0304157 A1
(43) Pub. Date: Oct. 2, 2025

(54) CONTROL DEVICE, CONTROL METHOD, AND STORAGE MEDIUM

(71) Applicant: Sony Honda Mobility Inc., Tokyo (JP)

(72) Inventor: Ryu Tate, Tokyo (JP)

(73) Assignee: Sony Honda Mobility Inc., Tokyo (JP)

(21) Appl. No.: 19/076,221

(22) Filed: Mar. 11, 2025

(30) Foreign Application Priority Data
Mar. 28, 2024 (JP) 2024-052781

(51) Int. Cl. B62D 6/00; B62D 15/02

(52) U.S. Cl. CPC B62D 6/008; B62D 15/029

(57) ABSTRACT

Provided is a control device for controlling vibrations generated by a vibration device group including at least a first vibration device and a second vibration device which are mounted on a driving operator of a vehicle, the control device including a control unit that causes the vibration device group to reproduce vibrations in a predetermined direction using the vibration of the first vibration device and the vibration of the second vibration device.

### CROSS-REFERENCE TO RELATED APPLICATION

Priority is claimed on Japanese Patent Application No. 2024-052781, filed Mar. 23, 2024, the content of which is incorporated herein by reference.

### BACKGROUND OF THE INVENTION

### Field of the Invention

The present invention relates to a control device, a control method, and a storage medium.

### Description of Related Art

Since the past, techniques of transmitting information to an occupant of a vehicle by vibrating a vibration device mounted on a driving operator of the vehicle have been known. For example, the following Patent Document 1 discloses a technique of transmitting navigation information to an occupant of a vehicle by driving a plurality of actuators included in a steering mechanism of the vehicle. The following Patent Document 2 discloses a technique of transmitting information indicating a left turn or a right turn to an occupant of a vehicle by vibrating a left vibrator or a right vibrator disposed on the steering wheel of the vehicle.

[Patent Document 1] U.S. Pat. No. 9,623,907

[Patent Document 2] U.S. Pat. No. 10,286,922

### SUMMARY OF THE INVENTION

However, the technique disclosed in Patent Document 1 requires a plurality of actuators for its implementation, which incurs high costs. On the other hand, the technique disclosed in Patent Document 2 does not make it possible to clearly transmit information to an occupant of a vehicle, because even when only the left or right vibrator is driven, the vibration actually propagates to the other side.

An aspect of the present invention was contrived in view of such circumstances, and an object thereof is to provide a control device, a control method, and a storage medium that make it possible to clearly transmit information to an occupant of a vehicle through the vibration of a vibration device mounted on a driving operator of the vehicle while keeping costs down.

In order to solve the above problem and achieve such an object, the present invention adopts the following aspects.

(1) According to an aspect of the present invention, there is provided a control device for controlling vibrations generated by a vibration device group including at least a first vibration device and a second vibration device which are mounted on a driving operator of a vehicle, the control device including a control unit that causes the vibration device group to reproduce vibrations in a predetermined direction using the vibration of the first vibration device and the vibration of the second vibration device.

According to the above aspect, it is possible to clearly transmit information to an occupant of a vehicle through the vibration of a vibration device mounted on a driving operator of the vehicle while keeping costs down.

(2) In the above (1), the control device may further include a setting unit that sets a predetermined point at which the vibration of the first vibration device and the vibration of the second vibration device cancel each other out by setting an amplitude ratio between an amplitude of the vibration of the first vibration device and an amplitude of the vibration of the second vibration device, wherein the control unit may cause the vibration device group to reproduce vibrations in a predetermined direction by the setting unit changing the amplitude ratio in a time series to change the predetermined point. (3) In the above (2), the first vibration device and the second vibration device may be disposed on the left and right of the driving operator, respectively, and the control unit may cause the vibration device group to reproduce vibrations in a predetermined direction by the setting unit changing the predetermined point from one side of the driving operator to the other side in a time series.

(4) In the above (1), the first vibration device and the second vibration device may be disposed on the left and right of the driving operator, respectively, and the control unit may start the vibrations of the first vibration device and the second vibration device by making the vibration of one of the first vibration device and the second vibration device greater than the vibration of the other, and then cause the vibration device group to reproduce vibrations in a predetermined direction by making the vibration of the other greater than the vibration of the one.

According to the aspect of the present invention, it is possible to clearly transmit information to an occupant of a vehicle through the vibration of a vibration device mounted on a driving operator of the vehicle while keeping costs down.

### BRIEF DESCRIPTION OF THE DRAWINGS

FIG. 1 is a diagram schematically illustrating the interior of a vehicle cabin in which a steering wheel SW having vibration devices VD1 and VD2 is installed.

FIG. 2 is a diagram illustrating an exemplary configuration of a system including a control device 100.

FIG. 3 is a series of graphs illustrating content of vibration measurement data 130A and a vibration profile 130B.

FIG. 4 is a graph illustrating the effect of setting an amplitude ratio between the amplitude of the vibration device VD1 and the amplitude of the vibration device VD2.

FIG. 5 is a graph illustrating the effect of setting the frequency of the vibration devices VD1 and VD2.

FIG. 6 is a diagram illustrating an example of an application of the control device 100 to driving assistance.

FIG. 7 is a diagram illustrating another example of an application of the control device 100 to driving assistance.

FIG. 8 is a flowchart illustrating an example of a flow of processing executed by the control device 100.

FIG. 9 is a diagram illustrating an example of a method of transmitting a vibration direction using the vibration devices VD1 and VD2.

FIG. 10 is a diagram illustrating another example of a method of transmitting a vibration direction using the vibration devices VD1 and VD2.

FIG. 11 is a diagram illustrating an example of a method of mediating a steering vibration.

FIG. 12 is a diagram illustrating another example of a method of mediating a steering vibration.

### DETAILED DESCRIPTION OF THE INVENTION

Hereinafter, the present invention will be described on the basis of preferred embodiments.

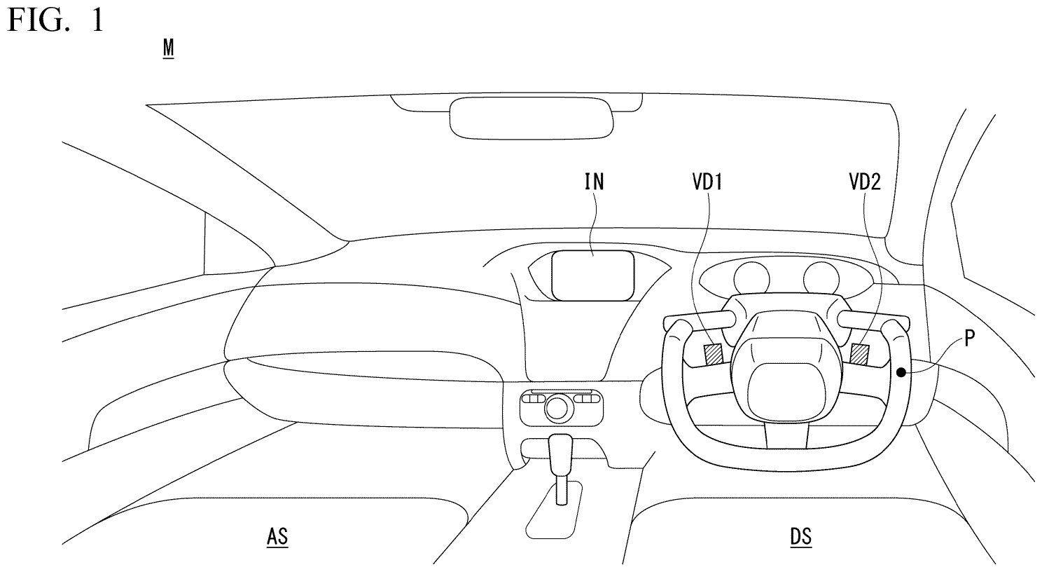

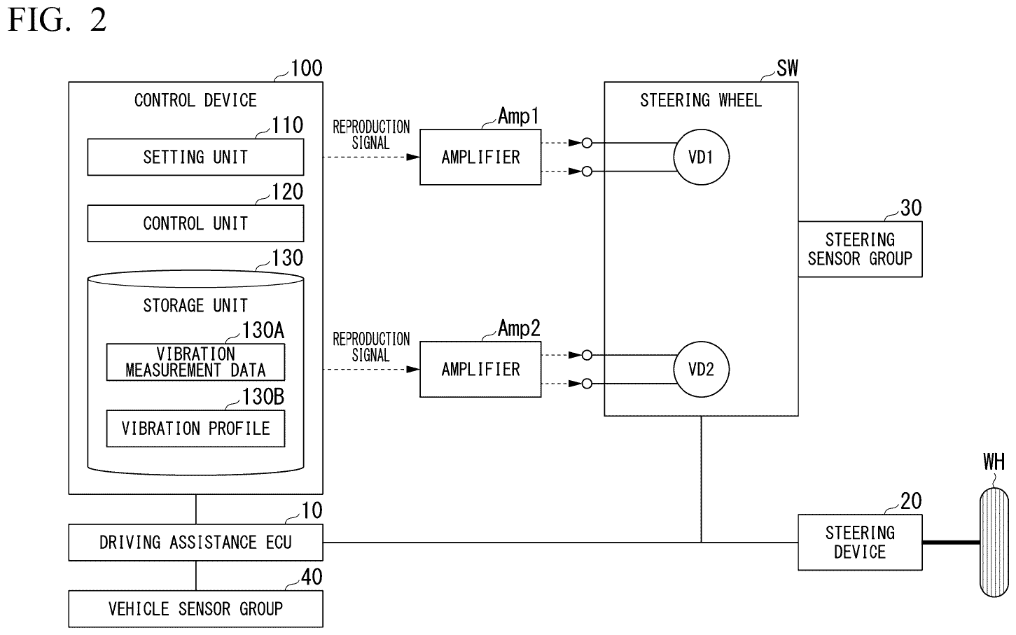

FIG. 1 is a diagram schematically illustrating the interior of a vehicle cabin in which a steering wheel SW having vibration devices VD1 and VD2 is installed. FIG. 2 is a diagram illustrating an exemplary configuration of a system including a control device 100 that controls a vibration device.

A vehicle M includes an instrument panel 11, a driver's seat DS, a passenger seat AS, the steering wheel SW, and the like within the vehicle cabin. The vehicle M is, for example, a two-wheeled, three-wheeled, or four-wheeled vehicle or the like, and the driving source thereof is an internal-combustion engine such as a diesel engine or a gasoline engine, an electric motor, or a combination thereof. FIG. 1 shows, as an example, a case where the vehicle M is a four-wheeled vehicle.

The steering wheel SW is equipped with a sensor that detects the amount of operation or the presence or absence of operation, and the detection results are output to a driving assistance ECU 10 and a steering device 20. The steering wheel SW does not necessarily have to be annular, and may be a variant steering wheel.

Further, the steering wheel SW is equipped with the vibration devices VD1 and VD2 on its left and right sides. The vibration devices VD1 and VD2 each have a built-in motor, and upon receiving a reproduction signal given by the control device 100 and amplified by an amplifiers Amp1 and Amp2, each vibration device operates the motor in accordance with the received reproduction signal to generate vibrations on the steering wheel SW. The amplifiers Amp1 and Amp2 are connected to the vibration devices VD1 and VD2, respectively, through cable reels. The motors built into the vibration devices VD1 and VD2 may be normal motors with no eccentricity in the center of gravity, or may be eccentric motors with an eccentricity in the center of gravity. As shown in FIG. 1, in the present embodiment, the vibration device VD1 is installed on the left side of the steering wheel SW with the purpose of transmitting vibrations to a driver's left hand which is gripping the steering wheel SW, while the vibration device VD2 is installed on the right side of the steering wheel SW with the purpose of transmitting vibrations the driver's right hand which is gripping the steering wheel SW.

The steering device 20 includes, for example, a steering ECU and an electric motor. The electric motor changes the direction of a turning wheel, for example, by causing a force to act on a rack and pinion mechanism. The steering ECU drives the electric motor in accordance with information input from the driving assistance ECU 10 or information input from the steering wheel SW, and changes the direction of the turning wheel.

The steering wheel SW is equipped with a steering sensor group 30. The steering sensor group 30 includes, for example, a steering grip sensor and a vibration displacement sensor. The steering grip sensor is realized by a capacitance sensor or the like, and outputs a signal that makes it possible to detect whether a driver is gripping the steering wheel SW (which means that the driver is in contact with the steering wheel while applying force) to the driving assistance ECU 10. The vibration displacement sensor measures the displacement [cm] of vibration generated at each position (point) on the steering wheel SW as a vibration intensity, and outputs the measured vibration intensity to the control device 100. In this case, the measured vibration intensity may be output directly to the control device 100 through the driving assistance ECU 10.

A vehicle sensor group 40 includes an image sensor installed to capture an image of a surrounding situation of the vehicle M using a solid-state imaging element such as a charge coupled device (CCD) or a complementary metal oxide semiconductor (CMOS), a vehicle speed sensor that detects the speed of the host vehicle M, an acceleration sensor that detects an acceleration, a yaw rate sensor that detects an angular velocity around a vertical axis, an orientation sensor that detects the direction of the host vehicle M, and the like. The driving assistance ECU 10 executes an advanced driver assistance system (ADAS) for a driver on the basis of the results of detection performed by the vehicle sensor group 40. Examples of the ADAS include a lane departure warning (LDW) that warns a driver of the host vehicle M deviating from the traveling lane, and the like. As will be described later, as an example, the driving assistance ECU 10 executes the ADAS by generating vibrations from the vibration devices VD1 and VD2 through the control device 100.

### Control Device

The control device 100 includes, for example, a setting unit 110, a control unit 120, and a storage unit 130. The setting unit 110 and the control unit 120 are each realized by a hardware processor such as, for example, a central processing unit (CPU) executing a program (software). Some or all of these components may be realized by hardware (a circuit unit; including circuitry) such as a large scale integration (LSI), an application specific integrated circuit (ASIC), a field-programmable gate array (FPGA), or a graphics processing unit (GPU), or a system on chip (SOC), and may be realized by software and hardware in cooperation. The program may be stored in advance in a storage device such as the HDD or the flash memory (a storage device including a non-transitory storage medium) of the control device 100, may be stored in a detachable storage medium such as a DVD or a CD-ROM, or may be installed in the HDD or the flash memory of the control device 100 by the storage medium (the non-transitory storage medium) being mounted in a drive device.

The storage unit 130 is realized by a storage device such as an HDD, a flash memory, or a random access memory (RAM). The storage unit 130 stores, for example, vibration measurement data 130A and a vibration profile 130B. The vibration measurement data 130A is data indicating the vibration intensity at a predetermined point P on the steering wheel SW, measured by the vibration displacement sensor when the vibration device VD1 vibrates. In the present embodiment, the predetermined point P represents a position on the steering wheel SW which is generally assumed to be most frequently gripped by the driver of the vehicle M while driving, and is determined in advance. The vibration profile 130B is definition information that defines the vibration (more specifically, the vibration intensity and phase) of the vibration device VD2 that cancels out the vibration generated by the vibration device VD1 at the predetermined point P on the basis of the vibration measurement data 130A.

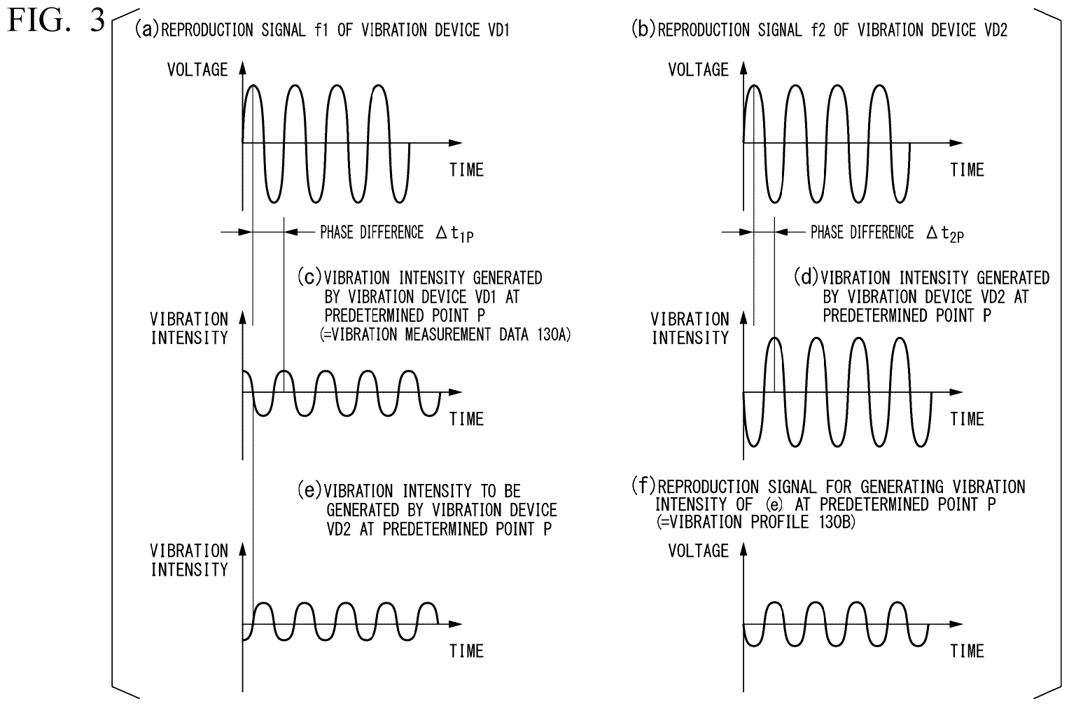

FIG. 3 is a series of graphs illustrating content of the vibration measurement data 130A and the vibration profile 130B. The graph of FIG. 3(a) shows a reproduction signal f₁ of the vibration device VD1 with the vertical axis representing voltage and the horizontal axis representing time. Hereinafter, the reproduction signal f₁ is expressed as f₁=V₁sin(2πft), where the voltage is set to V₁ and the frequency is set to f. Further, the graph of FIG. 3(b) shows a reproduction signal f₂ of the vibration device VD2 with the vertical axis representing voltage and the horizontal axis representing time. Hereinafter, the reproduction signal f₂ is expressed as f₂=V₂sin(2πft), where the voltage is set to V₂ and the frequency is set to f. That is, in the present embodiment, the frequency f given as the reproduction signal is assumed to be common to the vibration devices VD1 and VD2.

The graph of FIG. 3(c) shows time-series data of vibration intensity g_{1P} at a predetermined point P when the reproduction signal f₁ shown in the graph of FIG. 3(a) is applied to the vibration device VD1 to generate vibration. Since there is a phase difference between when the reproduction signal f₁ is applied to the vibration device VD1 and when vibration generated by the vibration device VD1 is transmitted to the predetermined point P, if this phase difference is expressed as Δt _{1P}, the vibration intensity g_{1P} is expressed as g_{1P}=G_{1P}sin(2πf(t+Δt_{1P})). Here, G_{1P} represents the amplitude of the vibration generated at the predetermined point P due to the vibration generated by the vibration device VD1. The amplitude G_{1P} includes a damping constant according to the material of the steering wheel SW and the propagation distance from the vibration device VD1. The vibration intensity g_{1P} at the predetermined point P and the phase difference Δt_{1P} with respect to the reproduction signal f₁ which are shown in the graph of FIG. 3(c) are an example of the vibration measurement data 130A.

Similarly, the graph of FIG. 3(d) shows time-series data of vibration intensity g_{2P} at a predetermined point P when the reproduction signal f₂ shown in the graph of FIG. 3(b) is applied to the vibration device VD2 to generate vibration. Since there is a phase difference between when the reproduction signal f₂ is applied to the vibration device VD2 and when the vibration generated by the vibration device VD2 is transmitted to the predetermined point P, if this phase difference is expressed as Δt_{2P}, the vibration intensity g_{2P} is expressed as g_{2P}=G_{2P}sin(2πf(t+Δt_{2P})). Here, G_{2P} represents the amplitude of the vibration generated at the predetermined point P due to the vibration generated by the vibration device VD2. As shown in FIG. 1, in the present embodiment, since the predetermined point P is set at a position closer to the vibration device VD2 than to the vibration device VD1, the phase difference Δt_{2P} has a smaller value than the phase difference Δt_{1P}.

In this way, as shown in the graph of FIG. 3(c), in a case where the vibration device VD1 located on the left side of the steering wheel SW vibrates, the vibration propagates to the predetermined point P located on the right side of the steering wheel SW. However, as described above, since the vibration device VD1 is intended to transmit vibration to the driver's left hand which is gripping the steering wheel SW, the propagation of the vibration of the vibration device VD1 to the predetermined point P will impair the clarity of the vibration transmitted to the driver's left hand.

In light of such circumstances, in the present embodiment, in a case where the vibration device VD1 is vibrated to transmit vibration to the driver's left hand, the vibration device VD2 is vibrated so as to cancel out the vibration at the predetermined point P caused by the vibration. More specifically, in order to cancel out the vibration at the predetermined point P shown in the graph of FIG. 3(c), a vibration intensity g_{2P}′ having the same vibration intensity as the vibration intensity g_{1P} in FIG. 3(c) and an opposite phase which is shown in the graph of FIG. 3(e) is generated at the predetermined point P by the vibration device VD2. As described above, since the vibration intensity g_{1P} is expressed as g_{1P}=G_{1P}sin(2πf(t+Δt_{1P})), the vibration intensity g_{2P}′ can be expressed as g_{2P}′=G_{2P}sin(2πf(t+Δt_{2P})+π) by advancing the phase of the vibration intensity g_{1P} by π.

Further, considering the correspondence relation between the reproduction signal f₂=V₂sin(2πft) described above and the vibration intensity g_{2P}=G_{2P}sin(2πf(t+αt_{2P})), a reproduction signal f₂′ of the vibration device VD2 corresponding to the vibration intensity g_{2P}′ can be expressed as f₂′=V₂(G_{1P}/G_{2P})sin(2πf(t−Δt_{2P}+Δt_{1P}+1/(2f))). That is, the reproduction signal f₂′ is an example of the vibration profile 130B.

In this way, the setting unit 110 sets the reproduction signal f₂′ for the vibration device VD2 to reproduce the vibration intensity g_{2P}′ that cancels out the vibration intensity g_{1P} at the predetermined point P caused by the vibration of the vibration device VD1 on the basis of the vibration measurement data 130A including the vibration intensity g_{1P} and the phase difference Δt_{1P} with respect to the reproduction signal f₁. When the vibration device VD1 is vibrated, the control unit 120 vibrates the vibration device VD2 in accordance with the vibration profile 130B. Consequently, in a case where the vibration device VD1 located on the left side of the steering wheel SW vibrates, the vibration device VD2 is also vibrated in accordance with the vibration profile 130B, to thereby prevent the vibration of the vibration device VD1 from propagating to the predetermined point P located on the right side of the steering wheel SW, and the driver can feel the vibration on the left side of the steering wheel SW more clearly.

In the above, a case has been described in which the vibration device VD1 is installed on the left side of the steering wheel SW, the vibration device VD2 is installed on the right side of the steering wheel SW, the predetermined point P is set on the right side of the steering wheel SW, and the vibration at the predetermined point P caused by the vibration of the vibration device VD1 is canceled out by the vibration of the vibration device VD2. However, the present invention is not limited such a configuration, and the above relationship may be reversed. Further, more generally, the vibration device VD1 and the vibration device VD2 need only be installed so that at least their vibration directions are parallel to each other. This makes it possible for the vibration at the predetermined point P caused by the vibration of one of the vibration device VD1 and the vibration device VD2 to be canceled out by the vibration of the other.

### Setting of Amplitude Ratio and Frequency

The setting unit 110 may further set not only the vibration profile 130B of the vibration device VD2, but also the amplitude ratio between the amplitude of the vibration device VD1 and the amplitude of the vibration device VD2, and the frequency f of the vibration devices VD1 and VD2. This makes it possible to adjust the position of the predetermined point P where the vibrations cancel each other out and the clarity of the vibration on one side of the steering wheel SW. The details thereof will be described below.

First, if the point (distance) on the steering wheel SW measured counterclockwise with the installation position of the vibration device VD1 set to zero is denoted by x and the time is denoted by t, the vibration intensity A at point x and time t is expressed as A(x, t)=ae^{-vx}sin{2πf(x/v+t)+θ₀ₓₜ}. Here, a represents a coefficient according to the propagation characteristics from the vibration source to point x, b represents damping according to the propagation characteristics from the vibration source to point x, f represents the frequency of the vibration, v represents the propagation speed of the vibration, and θ₀ₓₜ represents the initial phase of the vibration at time zero at point x. If the vibration at the predetermined point P propagated counterclockwise from the vibration device VD1 is denoted by A₁(x, t), the vibration at the predetermined point P propagated clockwise from the vibration device VD1 is denoted by A₂(x, t), the vibration at the predetermined point P propagated counterclockwise from the vibration device VD2 is denoted by A₃(x, t), and the vibration at the predetermined point P propagated clockwise from the vibration device VD2 is denoted by A₄(x, t), these vibrations are expressed by the following equations, respectively: A₁(x, t)=a₁e^{-bx}sin{2πf(x/v+t)}, A₂(x, t)=a₁e^{-b(11-x)}sin{2πf ((11−x)/v+t)}, A₃(x, t)=a₂e^{-b(x+12)}sin{2πf((x+12)/v+t+θ₀ₓₜ)}, and A₄(x, t)=a₂e^{-b(13-x)}sin{2πf((13−x)/v+t+θ₀ₓₜ)}. Here, 11−x represents the clockwise distance from the vibration device VD1 to the predetermined point P, x+12 represents the counterclockwise distance from the vibration device VD2 to the predetermined point P, and 13−x represents the clockwise distance from the vibration device VD2 to the predetermined point P. Under the above assumptions, if A(x, t) is simply expressed by a two-vibration source×two-path vibration propagation model, A(x, t)=A₁(x, t)+A₂(x, t)+A₃(x, t)+A₄(x, t)=a₁e^{-bx}sin{2πf(x/v+t)}+a₁e^{-b(}11−x)sin{2πf((11−x)/v+t)}+a₂e^{-b(x+12)}sin {2πf((x+12)/v+t+θ₀ₓₜ)}+a₂e^{-b(13-x)}sin{2πf((13−x)/v+t+θ₀ₓₜ)} is obtained.

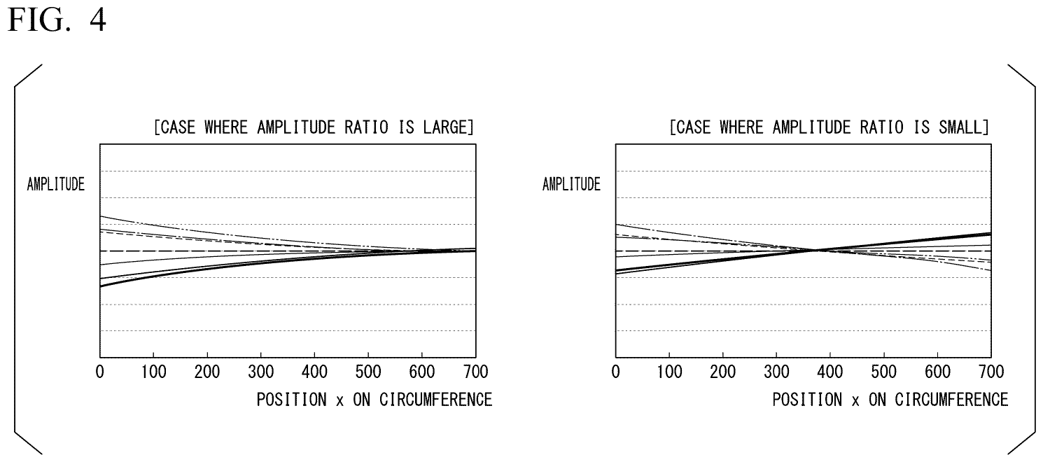

FIG. 4 is a graph illustrating the effect of setting an amplitude ratio between the amplitude of the vibration device VD1 and the amplitude of the vibration device VD2. The graph shown in FIG. 4 was obtained by changing the amplitude ratio a1/a2 between the amplitude a1 of the vibration generated by the vibration device VD1 and the amplitude a2 of the vibration generated by the vibration device VD2 in the two-vibration source×two-path vibration propagation model A(x, t) constructed above. As shown in the graph of FIG. 4, the larger the amplitude ratio between the amplitude a1 of the vibration generated by the vibration device VD1 and the amplitude a2 of the vibration generated by the vibration device VD2, the farther the position where the vibration generated by the vibration device VD1 and the vibration generated by the vibration device VD2 weaken each other (counterclockwise from the vibration device VD1), whereas the smaller the amplitude ratio, the closer the position where the vibration generated by the vibration device VD1 and the vibration generated by the vibration device VD2 weaken each other (counterclockwise from the vibration device VD1). Therefore, in accordance with the determination of the predetermined point P, the setting unit 110 can set the amplitude ratio so that the vibration generated by the vibration device VD1 and the vibration generated by the vibration device VD2 cancel each other out at the predetermined point P.

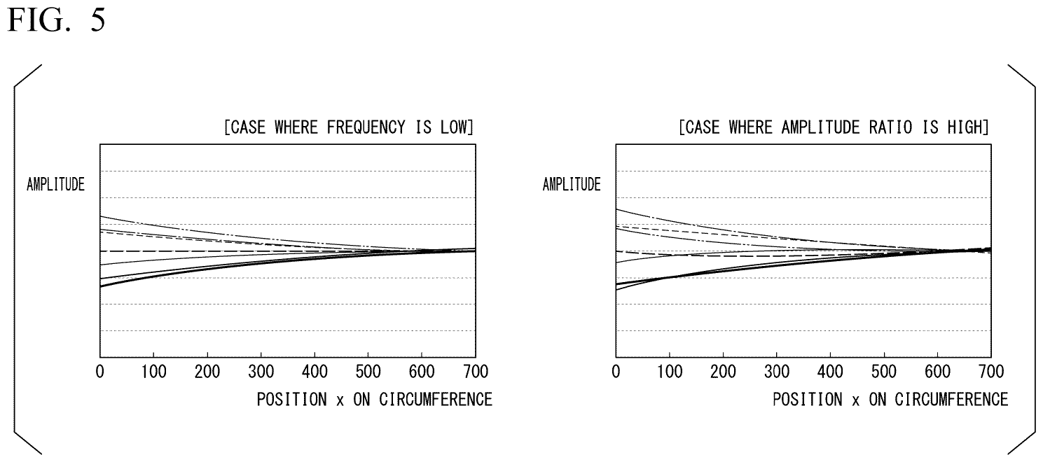

FIG. 5 is a graph illustrating the effect of setting the frequency of the vibration devices VD1 and VD2. In the same way as in FIG. 4, the graph shown in FIG. 5 was obtained by changing the frequency f of the vibrations generated by the vibration devices VD1 and VD2 in the two-vibration source×two-path vibration propagation model A (x, t).

As shown in the graph of FIG. 5, the higher the frequency of the vibrations generated by the vibration devices VD1 and VD2, the greater the difference in vibration intensity between the position where the vibration generated by the vibration device VD1 and the vibration generated by the vibration device VD2 reinforce each other and the position where these vibrations weaken each other (in other words, the difference between the left and right vibrations felt by a driver), whereas the lower the frequency of the vibrations generated by the vibration devices VD1 and VD2, the smaller the difference in vibration intensity between the position where the vibration generated by the vibration device VD1 and the vibration generated by the vibration device VD2 reinforce each other and the position where these vibrations weaken each other. This is because the higher the frequency of vibration, the shorter the wavelength, and thus the number of antinodes and nodes of the vibration propagating through the steering wheel SW increases, resulting in a shorter distance between the antinodes and nodes and making it easier for a difference between strength and weakness to occur within the steering wheel SW.

Therefore, by the setting unit 110 setting the frequency of the vibrations generated by the vibration devices VD1 and VD2 to be higher, the driver of the vehicle M can more clearly feel the vibration generated by the vibration device VD1 (or VD2) on the left side (or the right side) of the steering wheel SW. Since the degree to which it is preferable to discriminately express the vibrations on the left and right sides varies depending on the driver of the vehicle M, the setting unit 110 may, for example, receive an input related to the frequency settings from the driver of the vehicle M through the instrument panel 11. In that case, the setting unit 110 may display query information on the instrument panel 11 in a format that is more understandable to the driver, such as “make the left/right difference clearer/ambiguous,” instead of the numerical value of frequency. In yet another aspect, the setting unit 110 may measure the reaction period from when the vibration device VD1 (VD2) generates vibration to when the driver of the vehicle M reacts to it and executes a predetermined action (for example, a steering operation), and set the frequency to be higher to make an adjustment so that the difference between the left and right vibrations is made more clear in a case where the reaction period is determined to be long (for example, equal to or greater than a threshold).

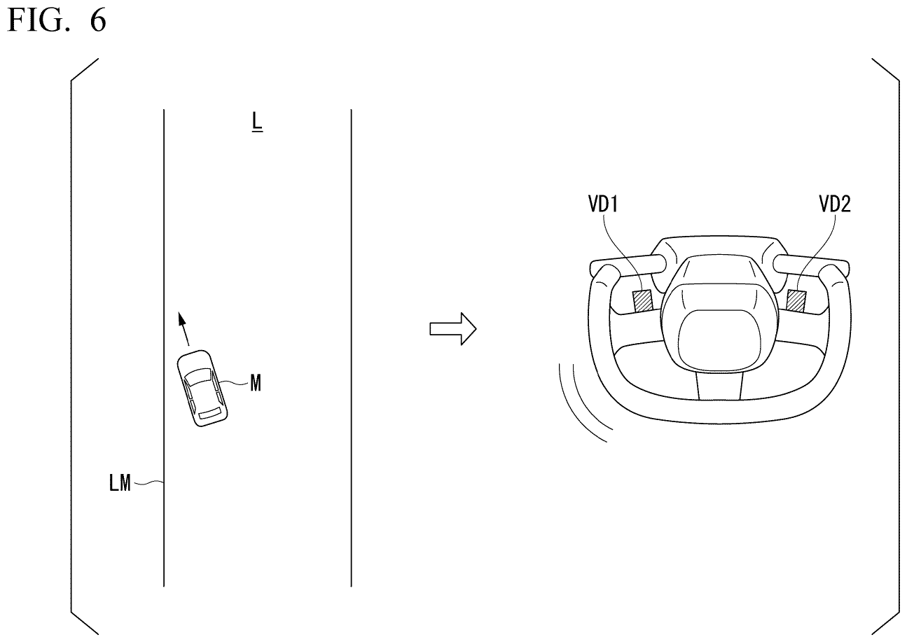

FIG. 6 is a diagram illustrating an example of an application of the control device 100 to driving assistance. The left portion of FIG. 6 shows a situation in which the vehicle M is traveling in a traveling lane L and is about to deviate from a lane LM. The driving assistance ECU 10 recognizes, for example, the lane LM shown in an image representing the surrounding situation of the vehicle M on the basis of the image output by an image sensor included in the vehicle sensor group 40. The driving assistance ECU 10 then determines whether the distance between the vehicle M and the recognized lane LM falls within a threshold. In a case where it is determined that the distance between the vehicle M and the recognized lane LM falls within the threshold, the driving assistance ECU 10 transmits a command value to the control device 100 so as to vibrate the vibration device VD1 (VD2) corresponding to the side (left or right) where the distance falls within the threshold.

When the control device 100 receives the command value, the control unit 120 transmits a reproduction signal so as to vibrate the vibration device VD1 (VD2) on the side indicated by the command value, and also transmits a reproduction signal so as to vibrate the vibration device VD2 (VD1) on the opposite side in accordance with the vibration profile 130B. In the case of FIG. 6, the control unit 120 transmits a reproduction signal so as to vibrate the left vibration device VD1, and also transmits a reproduction signal so as to vibrate the right vibration device VD2 in accordance with the vibration profile 130B. This causes only the left portion of the steering wheel SW to be vibrated as shown in the right portion of FIG. 6, allowing the driver of the vehicle M to more clearly ascertain the situation in which the vehicle M is about to deviate toward the left side of the lane LM.

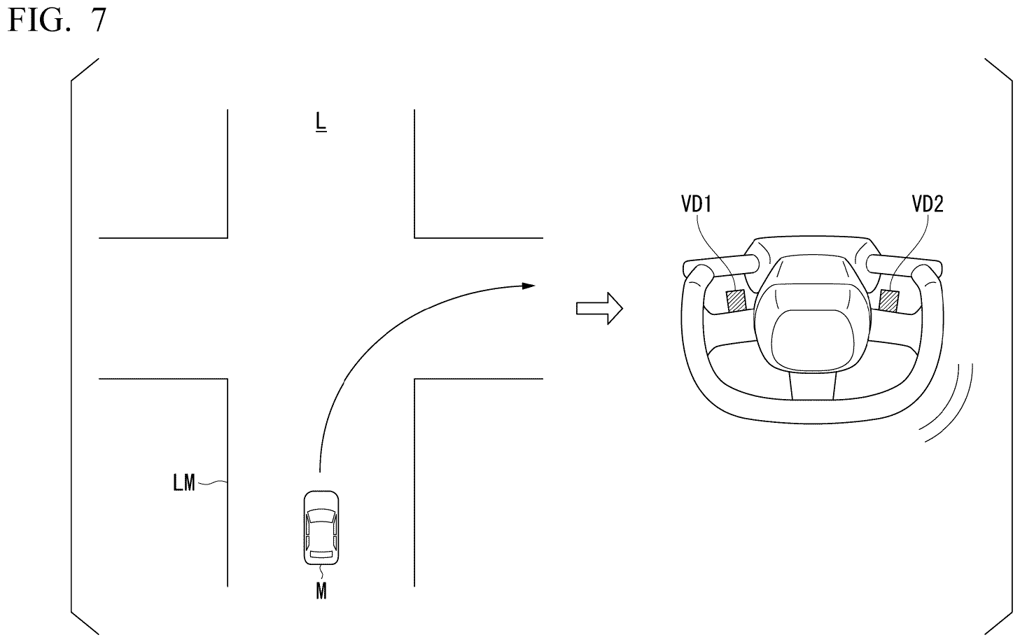

FIG. 7 is a diagram illustrating another example of an application of the control device 100 to driving assistance. The left portion of FIG. 7 shows, for example, a situation in which the vehicle M is about to make a right turn in the traveling lane L in accordance with navigation information displayed on the instrument panel 11. The driving assistance ECU 10 recognizes, for example, a point of intersection present in front of the vehicle M on the basis of an image representing the surrounding situation of the vehicle M output by an image sensor included in the vehicle sensor group 40. The driving assistance ECU 10 then determines whether the distance between the vehicle M and the recognized point of intersection falls within the threshold. In a case where it is determined that the distance between the vehicle M and the recognized point of intersection falls within the threshold, the driving assistance ECU 10 transmits a command value to the control device 100 so as to vibrate the vibration device VD1 (VD2) corresponding to the side (left or right) where the vehicle M is entering.

When the control device 100 receives the command value, the control unit 120 transmits a reproduction signal so as to vibrate the vibration device VD1 (VD2) on the side indicated by the command value, and also transmits a reproduction signal so as to vibrate the vibration device VD2 (VD1) on the opposite side in accordance with the vibration profile 130B. In the case of FIG. 7, the control unit 120 transmits a reproduction signal so as to vibrate the right vibration device VD2, and also transmits a reproduction signal so as to vibrate the right vibration device VD1 in accordance with the vibration profile 130B. This causes only the right portion of the steering wheel SW to be vibrated as shown in the right portion of FIG. 7, allowing the driver of the vehicle M to more clearly ascertain the situation in which a right-turn operation at the point of intersection is required.

The form of driving assistance described above is merely an example, and the vibration generated by the vibration device VD1 (VD2) may be used for other driving assistance or entertainment. For example, the driving assistance ECU 10 determines there is an obstacle (for example, another vehicle or a pedestrian) in the vicinity of the vehicle M on the basis of an image representing the surrounding situation of the vehicle M, and in a case where it is determined that there is an obstacle in the vicinity of the vehicle M, the driving assistance ECU 10 may transmit a command value to the control device 100 so as to vibrate the vibration device VD1 (VD2) corresponding to the side (left or right) where there is an obstacle. For example, as an application to entertainment, the driving assistance ECU 10 (or a separately prepared ECU) may refer to map information or news information while the vehicle M is traveling, and in a case where there is some kind of facility (such as a tourist facility) or an event (such as a festival) on the left-hand side or the right-hand side of the vehicle M, transmit a command value to the control device 100 so as to vibrate the vibration device VD1 (VD2) corresponding to the direction of the facility or event. At that time, the driving assistance ECU 10 may also display guidance information relating to the facility or event on the instrument panel 11. For example, as another application to entertainment, the driving assistance ECU 10 (or a separately prepared ECU) may transmit a command value to the control device 100 so as to vibrate the vibration devices VD1 and VD2 alternately left and right in time to the rhythm of music while the vehicle M is playing the music.

Further, in the present embodiment, for the sake of simplicity, a case is described in which two vibration devices, that is, the vibration devices VD1 and VD2, are installed on the steering wheel SW as a vibration device group, and the profile of the vibration device VD2 is set so that the vibration generated by the vibration device VD1 at the predetermined point P is canceled out by the vibration of the vibration device VD2. However, the present invention is not limited to such a configuration, and three or more vibration devices (for example, vibration devices VD1 to VD3) may be installed on the steering wheel SW. In that case, for example, the profiles of the vibration devices VD2 and VD3 may be set so that the vibration generated by the vibration device VD1 at the predetermined point P is canceled out by the vibrations of the vibration devices VD2 and VD3.

Further, in the present embodiment, the predetermined point P is set in advance at a position which is generally assumed to be most frequently gripped by the driver of the vehicle M while driving. However, the present invention is not limited to such a configuration, and the setting unit 110 may set the position on the steering wheel SW which is most frequently gripped by the driver during a predetermined period as the predetermined point P on the basis of the detection results of the steering grip sensor, and adjust the amplitude ratio in accordance therewith. In this case, the sensor for detecting the driver's grip position is not limited to the steering grip sensor, and the driver's grip position may be detected by a time of flight (ToF) sensor that measures the positions of both hands of the driver or an image sensor that captures images of both hands of the driver. This makes it possible to clearly transmit information to the driver of the vehicle.

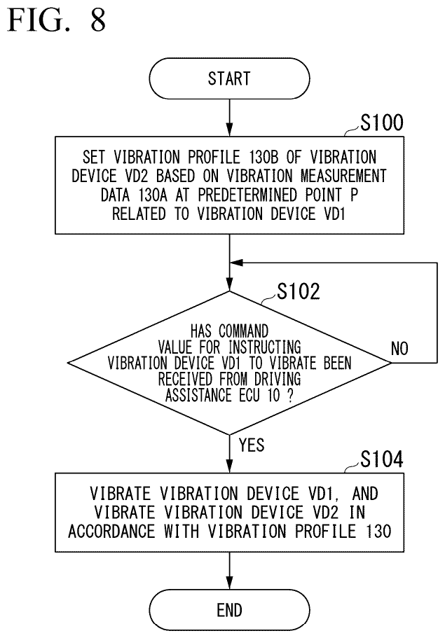

Next, a flow of processing executed by the control device 100 will be described with reference to FIG. 8. FIG. 8 is a flowchart illustrating an example of a flow of processing executed by the control device 100.

First, the setting unit 110 sets the vibration profile 130B of the vibration device VD2 on the basis of the vibration measurement data 130A at the predetermined point P related to the vibration device VD1 (step S100). Next, the control unit 120 determines whether a command value for instructing the vibration device VD1 to vibrate has been received from the driving assistance ECU 10 (step S102). In a case where it is determined that the command value for instructing the vibration device VD1 to vibrate has not been received from the driving assistance ECU 10, the control unit 120 executes the process of step S102 again after a predetermined period. On the other hand, in a case where it is determined that the command value for instructing the vibration device VD1 to vibrate has been received from the driving assistance ECU 10, the control unit 120 vibrates the vibration device VD1 and vibrates the vibration device VD1 in accordance with the vibration profile 130B (step S104). This completes the process of this flowchart.

### Reproduction of Vibration Direction

As described above, in the present embodiment, the control unit 120 operates the vibration devices VD1 and VD2 so that the vibration generated by the vibration device VD1 is canceled out by the vibration generated by the vibration device VD2 at the predetermined point P, thereby realizing clear information transmission through the vibrations of the vibration devices. In another aspect, the control unit 120 may realize clear information transmission by controlling the vibration device VD1 located on the left side of the steering wheel SW and the vibration device VD2 located on the right side thereof so that the vibrations generated by these vibration devices transmit (reproduce) the vibration direction to the driver.

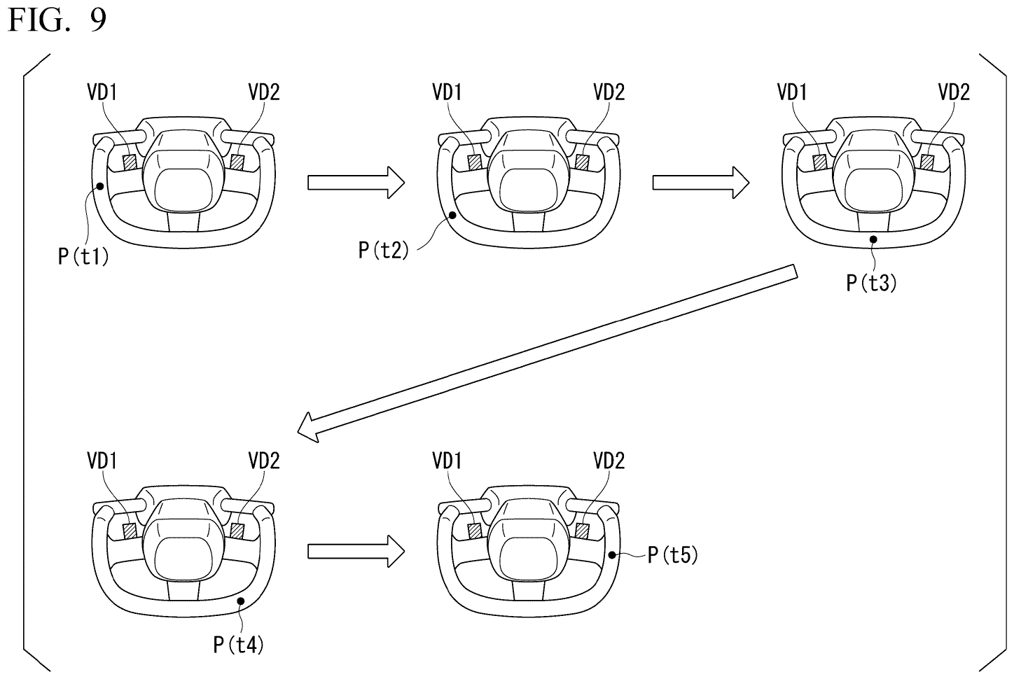

FIG. 9 is a diagram illustrating an example of a method of transmitting a vibration direction using the vibration devices VD1 and VD2. FIG. 9 shows a case where the vibration direction is transmitted from left to right from a point in time t1 to a point in time t5 using the vibration devices VD1 and VD2. As shown in FIG. 4, the setting unit 110 first sets the amplitude ratio between the amplitude al of the vibration generated by the vibration device VD1 and the amplitude a2 of the vibration generated by the vibration device VD2 to be small at the point in time t1, thereby setting a predetermined point P(t1) to the left side of the steering wheel SW. In a state where the predetermined point P(t1) is set, the control unit 120 vibrates the vibration devices VD1 and VD2, thereby increasing (maximize) the vibration on the left side of the steering wheel SW while decreasing (minimize) the vibration on the right side of the steering wheel SW.

Thereafter, at the point in time t2, the setting unit 110 sets the amplitude ratio to be larger than that at the point in time t1, thereby setting the predetermined point P(t2) to the right side of the steering wheel SW relative to the predetermined point P(t1). In a state where the predetermined point P(t2) is set, the control unit 120 vibrates the vibration devices VD1 and VD2, thereby decreasing the vibration on the left side of the steering wheel SW while increasing the vibration on the right side of the steering wheel SW. By repeating such a process from the point in time t3 to the point in time t5, the vibration on the left side of the steering wheel SW gradually decreases while the vibration on the right side of the steering wheel SW gradually increases, which makes it possible for the driver of the vehicle M to feel the vibration direction from left to right. That is, this makes it possible to transmit the vibration direction to the driver of the vehicle M. The settings from the point in time t1 to the point in time t5 shown in FIG. 9 are merely an example, and the points in time to be controlled may be set more finely, or may be set more roughly.

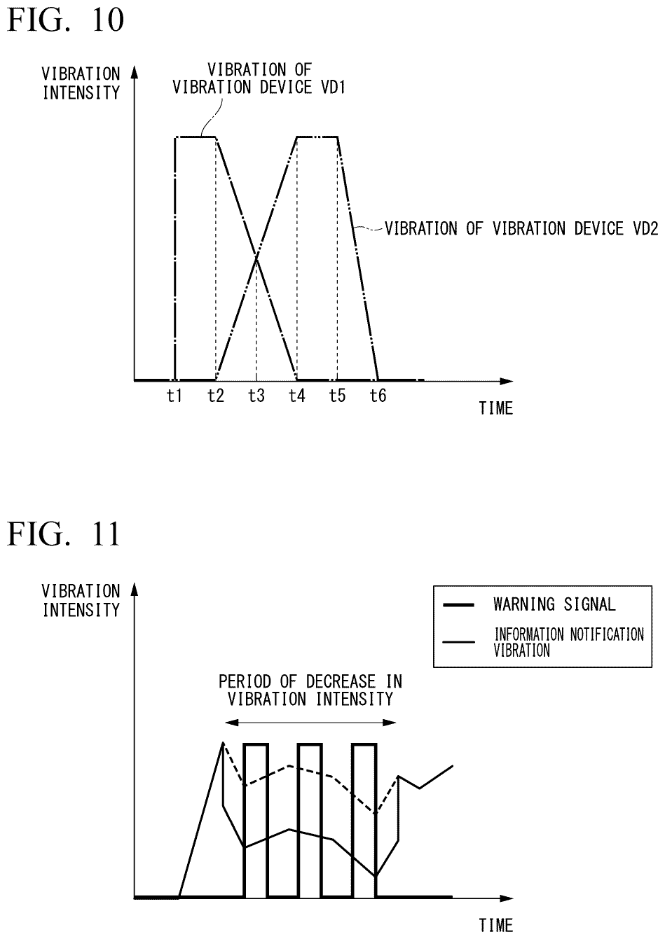

FIG. 10 is a diagram illustrating another example of a method of transmitting a vibration direction using the vibration devices VD1 and VD2. In the graph shown in FIG. 10, the dashed-dotted line represents the vibration of the vibration device VD1, and the dashed-two dotted line represents the vibration of the vibration device VD2. FIG. 10 shows a case where the vibration direction is transmitted from left to right using the vibration devices VD1 and VD2.

First, at the point in time t1, the control unit 120 vibrates the vibration device VD1 at the maximum vibration intensity and continues for a certain period of time (that is, from the point in time t1 to the point in time t2). Next, at the point in time t2, the control unit 120 reduces the vibration of the vibration device VD1 while increasing the vibration of the vibration device VD2. As a result, at the point in time t3, the vibration intensity of the vibration device VD2 is reversed to the vibration intensity of the vibration device VD1. Next, at the point in time t4, the control unit 120 stops the vibration of the vibration device VD1, while vibrating the vibration device VD2 at the maximum vibration intensity. Next, the control unit 120 reduces the vibration of the vibration device VD2 at the point in time t5, and stops the vibration of the vibration device VD2 at the point in time t6. Through such a process, the vibration on the left side of the steering wheel SW gradually decreases from the maximum value, while the vibration on the right side of the steering wheel SW gradually increases from the minimum value, so that the driver of the vehicle M can feel the vibration direction from left to right. That is, this makes it possible to transmit the vibration direction to the driver of the vehicle M. The transition of the vibration intensity shown in FIG. 10 is a linear increase or decrease, but this is merely an example, and it is sufficient that at least one of the vibration devices VD1 and VD2 starts to generate vibration with a vibration intensity greater than the other, and then the intensity of vibration generated by the other device is reversed to that of the one device.

As in the cases of FIGS. 6 and 7, the control unit 120 can apply the transmission of vibration direction using the vibration devices VD1 and VD2 to driving assistance and entertainment. For example, when the vehicle M makes a right turn (left turn), the control unit 120 may transmit the direction of travel to the driver by controlling the vibration devices VD1 and VD2 so as to transmit the vibration direction from left to right (from right to left). For example, while the vehicle M is playing music, the control unit 120 may entertain the driver by alternately reproducing the vibration direction from left to right and the vibration direction from right to left in time to the rhythm of the music.

### Mediation of Signal

As described with reference to FIGS. 6 and 7, in cooperation with the driving assistance ECU 10, the control unit 120 can activate warning vibrations to warn of lane departure, the presence of an obstacle, or the like, or activate information notification vibrations for navigation or entertainment by providing a reproduction signal to the vibration device. However, there are limitations on the number and cost of vibration devices that can be installed on the steering wheel SW, and thus in a case where a plurality of activation conditions related to steering vibrations are established simultaneously, it is necessary to mediate between these steering vibrations.

Therefore, the control unit 120 realizes the mediation of steering vibrations by lowering the vibration effect of a vibration having a low priority among a plurality of types of vibration (such as, for example, warning vibration, information notification vibration, or entertainment vibration) on the basis of priorities defined for the plurality of types of vibration. More specifically, for example, the control unit 120 lowers the vibration effect of a reproduction signal that activates an information notification vibration relative to a reproduction signal that activates a warning vibration. The following description is not based on the cooperation between the vibration devices VD1 and VD2. For example, the same can also be applied to a case where one vibration device is installed on the steering wheel SW, and thus it is simply referred to as the vibration device VD.

FIG. 11 is a diagram illustrating an example of a method of mediating a steering vibration. In the graph shown in FIG. 11, the thick solid line represents a warning vibration, and the thin solid line represents an information notification vibration. In a case where the activation condition for a warning vibration and the activation condition for an information notification vibration are established simultaneously, the control unit 120 reduces the vibration effect by, for example, decreasing the vibration intensity of the reproduction signal corresponding to the information notification vibration by a predetermined value. In the case of the graph shown in FIG. 11, the dotted line represents the vibration intensity of the information notification vibration before vibration intensity is decreased. During the period of a decrease in vibration intensity, the control unit 120 outputs a reproduction signal corresponding to the warning vibration to the vibration device VD at the same time that the vibration intensity of the reproduction signal corresponding to the information notification vibration is decreased. In the case of FIG. 11, the control unit 120 outputs a reproduction signal corresponding to the warning vibration to the vibration device VD three times. This allows the driver of the vehicle M to feel the vibration corresponding to the warning vibration more strongly than the vibration corresponding to the information notification vibration during the period of a decrease in vibration intensity, and thus it is possible to realize the mediation of the steering vibration.

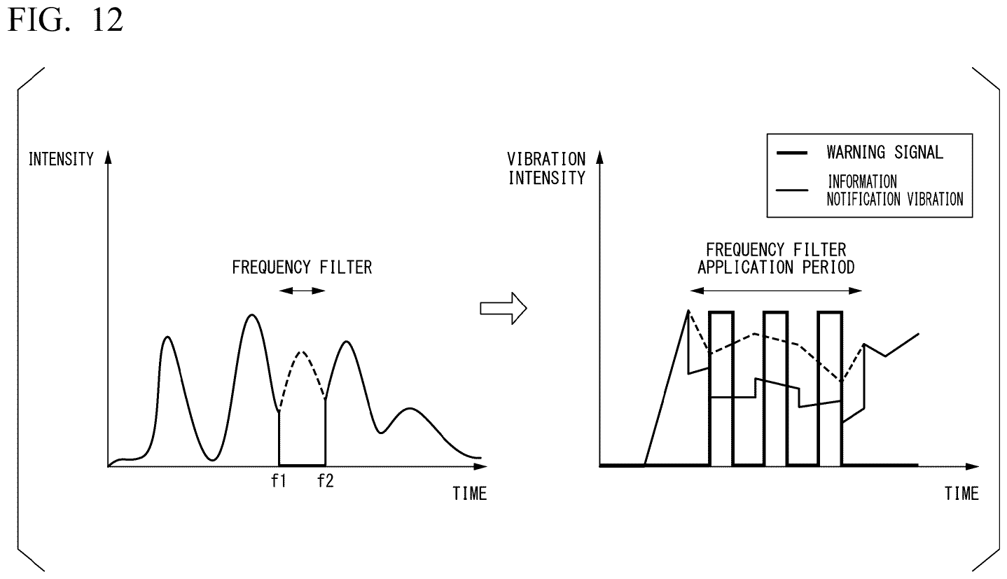

FIG. 12 is a diagram illustrating another example of a method of mediating a steering vibration. In a case where the activation condition for the warning vibration and the activation condition for the information notification vibration are established simultaneously, the control unit 120 applies a frequency filter to reduce the vibration effect, for example, by canceling some or all of the frequencies that make up the reproduction signal of the information notification vibration. The left portion of FIG. 12 shows a case where the control unit 120 applies a frequency filter that cancels the frequency band from frequency f1 to frequency f2 to the reproduction signal of the information notification vibration. Thereby, as shown in the right portion of FIG. 12, the information notification vibration corresponding to the solid line is output from the vibration device VD instead of the information notification vibration corresponding to the dotted line. The information notification vibration that has undergone the filter and has been modified in this way becomes a vibration that the driver of the vehicle M would not normally recognize as the information notification vibration. This allows the driver of the vehicle M to feel the vibration corresponding to the warning vibration more clearly than the vibration corresponding to the information notification vibration during the frequency filter application period. That is, this makes it possible to realize the mediation of the steering vibration.

Although the case of mediating between the warning vibration and the information notification vibration has been described in FIGS. 11 and 12, the present invention is not limited to such a configuration, and the above steering mediation can be applied to a plurality of different types of vibration. For example, in a case where the activation condition for the information notification vibration and the activation condition for the entertainment vibration are established simultaneously, the control unit 120 may apply a frequency filter for prioritizing the activation condition for the information notification vibration to the reproduction signal of the entertainment vibration.

According to the present embodiment described above, the vibration device group is caused to reproduce vibrations in a predetermined direction using the vibration of the first vibration device and the vibration of the second vibration device. This makes it possible to clearly transmit information to an occupant of a vehicle through the vibration of a vibration device mounted on a driving operator of the vehicle while keeping costs down.

What is claimed is:

1. A control device for controlling vibrations generated by a vibration device group including at least a first vibration device and a second vibration device which are mounted on a driving operator of a vehicle, the control device comprising:
a control unit that causes the vibration device group to reproduce vibrations in a predetermined direction using the vibration of the first vibration device and the vibration of the second vibration device.

2. The control device according to claim 1, further comprising a setting unit that sets a predetermined point at which the vibration of the first vibration device and the vibration of the second vibration device cancel each other out by setting an amplitude ratio between an amplitude of the vibration of the first vibration device and an amplitude of the vibration of the second vibration device,
wherein the control unit causes the vibration device group to reproduce vibrations in a predetermined direction by the setting unit changing the amplitude ratio in a time series to change the predetermined point.

3. The control device according to claim 2, wherein the first vibration device and the second vibration device are disposed on the left and right of the driving operator, respectively, and
the control unit causes the vibration device group to reproduce vibrations in a predetermined direction by the setting unit changing the predetermined point from one side of the driving operator to the other side in a time series.

4. The control device according to claim 1, wherein the first vibration device and the second vibration device are disposed on the left and right of the driving operator, respectively, and
the control unit starts the vibrations of the first vibration device and the second vibration device by making the vibration of one of the first vibration device and the second vibration device greater than the vibration of the other, and then causes the vibration device group to reproduce vibrations in a predetermined direction by making the vibration of the other greater than the vibration of the one.

5. A control method for controlling vibrations generated by a vibration device group including at least a first vibration device and a second vibration device which are mounted on a driving operator of a vehicle, the method comprising causing a computer to:
cause the vibration device group to reproduce vibrations in a predetermined direction using the vibration of the first vibration device and the vibration of the second vibration device.

6. A computer readable non-transitory storage medium having a program stored therein, the program controlling vibrations generated by a vibration device group including at least a first vibration device and a second vibration device which are mounted on a driving operator of a vehicle, and causing a computer to:
cause the vibration device group to reproduce vibrations in a predetermined direction using the vibration of the first vibration device and the vibration of the second vibration device.
